(19) United States
(12) Patent Application Publication
(10) Pub. No.: US 2025/0010687 A1
(43) Pub. Date: Jan. 9, 2025

(54) VEHICLE AIR-CONDITIONING DEVICE

(71) Applicant: DENSO CORPORATION, Kariya-city (JP)

(72) Inventors: Michihiro KACHI, Kariya-city (JP); Shinya KATO, Kariya-city (JP)

(21) Appl. No.: 18/888,551

(22) Filed: Sep. 18, 2024

Related U.S. Application Data
(63) Continuation of application No. PCT/JP2023/010647, filed on Mar. 17, 2023.

(30) Foreign Application Priority Data
Mar. 25, 2022 (JP) 2022-050176

(51) Int. Cl. B60H 1/00; B60S 1/54

(52) U.S. Cl. CPC B60H 1/00678; B60H 1/00692; B60S 1/54

(57) ABSTRACT

A vehicle air-conditioning device include an air conditioning case and a heating device. The air conditioning case is formed with a defroster opening and a side-face opening. A defroster door for opening and closing the defroster opening and a face door for opening and closing the side-face opening are provided inside the air conditioning case. The face door is a slide door that opens and closes the side-face opening by moving along an opening plane of the side-face opening. The air conditioning case has a structure in which air that has passed through the heating device is guided along an inner door surface of the face door to the defroster opening. A gap opening for communication between upstream and downstream of the face door in an air flow direction is formed. The gap opening has an opening plane along a moving direction of the face door.

### CROSS REFERENCE TO RELATED APPLICATIONS

The present application is a continuation application of International Patent Application No. PCT/JP2023/010647 filed on Mar. 17, 2023, which designated the U.S. and claims the benefit of priority from Japanese Patent Application No. 2022-050176 filed on Mar. 25, 2022. The entire disclosures of all of the above applications are incorporated herein by reference.

### TECHNICAL FIELD

The present disclosure relates to a vehicle air-conditioning device.

### BACKGROUND

A vehicle air-conditioning device blows a portion of a conditioned air into a vehicle compartment.

### SUMMARY

According to at least one embodiment, a vehicle air-conditioning device include an air conditioning case defining an air passage for air to be blown into a vehicle compartment of a vehicle and a heating device for heating air flowing through the air passage. The air conditioning case is formed with a defroster opening for blowing air toward an inner surface of a front windshield of the vehicle. Additionally, it has a side-face opening for blowing air into the vehicle compartment from end parts in a left-right direction of the vehicle. A defroster door for opening and closing the defroster opening and a face door for opening and closing the side-face opening are provided inside the air conditioning case. The face door is a slide door that opens and closes the side-face opening by moving along an opening plane of the side-face opening. The air conditioning case has a structure in which air that has passed through the heating device is guided along an inner door surface of the face door to the defroster opening in a face closed state, where the face door closes the side-face opening. A gap opening for communication between upstream and downstream of the face door in an air flow direction in the face closed state is formed adjacent to the side-face opening. The gap opening has an opening plane along a moving direction of the face door. The gap opening is configured to open and close.

### BRIEF DESCRIPTION OF THE DRAWINGS

The details of one or more embodiments are set forth in the accompanying drawings and the description below. Other features and advantages will be apparent from the description and drawings, and from the claims.

FIG. 1 is a schematic diagram of a vehicle air-conditioning device in a first embodiment.

FIG. 2 is a schematic diagram illustrating a vicinity of a face opening when viewed from a direction II in FIG. 1.

FIG. 3 is an explanatory diagram for explaining states of a mode switching door for each blowing mode.

FIG. 4 is an explanatory diagram for explaining air flow in a face mode.

FIG. 5 is an explanatory diagram for explaining a temperature of air passing through a defroster opening and a gap opening in a defroster mode.

FIG. 6 is an explanatory diagram for explaining air flow in a foot mode.

FIG. 7 is an explanatory diagram for explaining air flow in a foot defroster mode.

FIG. 8 is a schematic diagram of a vehicle air-conditioning device in a second embodiment.

### DETAILED DESCRIPTION

To begin with, examples of relevant techniques will be described.

Conventionally, there has been known a vehicle air-conditioning device that blows a portion of a conditioned air into a vehicle compartment from ends in a left-right direction of a vehicle through a gap that connects an upstream and downstream of a face door when a side-face opening is closed by the face door.

A vehicle air-conditioning device according to a comparative example is configured such that when the side-face opening is closed by the face door, warm air that has passed through a heater core flows along an inner surface of the face door. In addition, the gap that communicates the upstream and downstream of the face door opens in a direction intersecting the inner surface of the face door.

For this reason, in the vehicle air-conditioning device of the comparative example, when the side-face opening is closed by the face door, excessive high-temperature air heated by a heating equipment tends to flow into the gap connecting the upstream and downstream of the face door. In such a configuration, high-temperature air heated by the heating equipment is likely to be blown out excessively toward occupant's faces through the gap connecting the upstream and downstream of the face door, reducing comfort inside the vehicle compartment. These facts were found through intensive studies by the present inventors.

In contrast to the comparative example, according to a vehicle air-conditioning device of the present disclosure, high-temperature air heated by a heating device can be reduced from flowing excessively through a gap connecting an upstream and a downstream of a face door.

According to one aspect of the present disclosure, a vehicle air-conditioning device include an air conditioning case defining an air passage for air to be blown into a vehicle compartment of a vehicle and a heating device for heating air flowing through the air passage. The air conditioning case is formed with a defroster opening for blowing air toward an inner surface of a front windshield of the vehicle. Additionally, it has a side-face opening for blowing air into the vehicle compartment from end parts in a left-right direction of the vehicle. A defroster door for opening and closing the defroster opening and a face door for opening and closing the side-face opening are provided inside the air conditioning case. The face door is a slide door that opens and closes the side-face opening by moving along an opening plane of the side-face opening. The air conditioning case has a structure in which air that has passed through the heating device is guided along an inner door surface of the face door to the defroster opening in a face closed state, where the face door closes the side-face opening. A gap opening for communication between upstream and downstream of the face door in an air flow direction in the face closed state is formed adjacent to the side-face opening. The gap opening has an opening plane along a moving direction of the face door. The gap opening is configured to open and close.

According to this configuration, if the gap opening is opened along the moving direction of the face door, the warm air flowing along the inner door surface of the face door will be more likely to flow along the opening plane of the gap opening, thereby reducing excessive flow into the gap opening.

According to another aspect of the present disclosure, a vehicle air-conditioning device includes an air conditioning case defining an air passage for air to be blown into a vehicle compartment of a vehicle and a heating device for heating air flowing through the air passage. The air conditioning case is formed with a defroster opening for blowing air toward an inner surface of a front windshield of the vehicle. It also has side-face openings for blowing air into the vehicle compartment from end parts in a left-right direction of the vehicle. A defroster door for opening and closing the defroster opening and a face door for opening and closing the side-face openings are provided inside the air conditioning case. A gap opening is formed adjacent to the side-face opening for communication between upstream and downstream of the face door in an air flow direction in a face closed state, in which the face door closes the side-face opening. The air conditioning case has a ventilation structure in which, in the face closed state, air that has passed through the heating device is guided to the defroster opening along an opening plane of the gap opening. Additionally, air that has passed around the heating device flows in a direction which intersects with the opening plane of the gap opening. The gap opening is configured to open and close.

According to this configuration, the warm air that has passed through the heating device is capable of easily flowing along the opening plane of the gap opening to the defroster opening, and the cold air that flows around the heating device or the temperature-controlled air that is a mixture of the cold air and the warm air is capable of easily flowing to the gap opening.

Therefore, in the face closed state, the high-temperature air heated by the heating device is prevented from flowing excessively through the gap opening. In addition, in the face closed state, the high-temperature air heated by the heating device is capable of easily flowing through the defroster opening, thereby preventing the front windshield of the vehicle from fogging up.

Hereinafter, embodiments of the present disclosure will be described with reference to the drawings. In the following embodiments, portions that are the same as or equivalent to those described in the preceding embodiments are denoted by the same reference numerals, and a description of the same or equivalent portions may be omitted. In addition, when only a part of the components is described in the embodiment, the components described in the preceding embodiment can be applied to other parts of the components. The respective embodiments described herein may be partially combined with each other as long as no particular problems are caused even without explicit statement of these combinations.

### First Embodiment

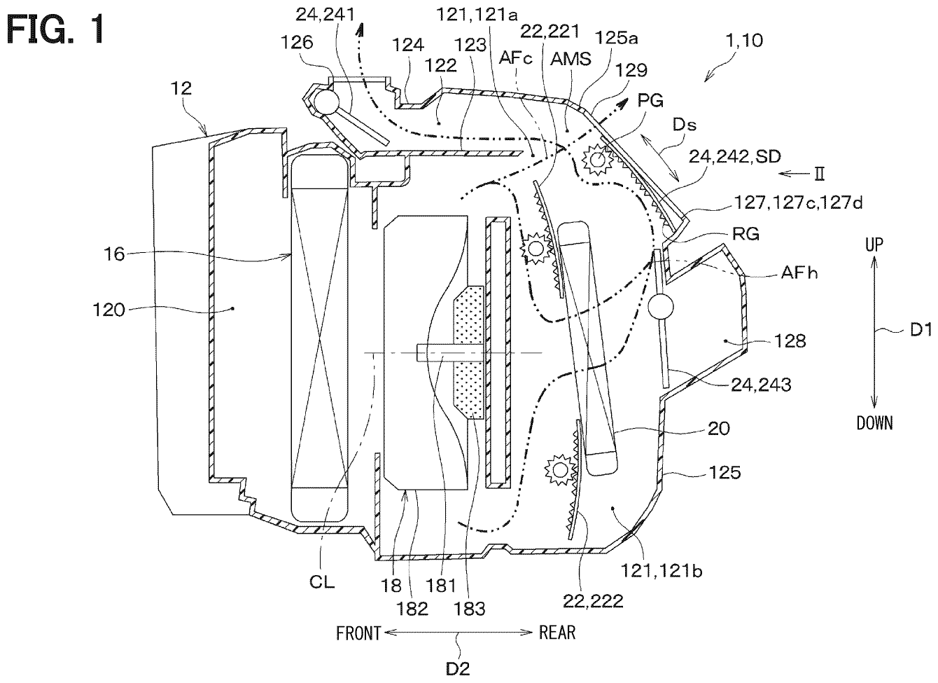

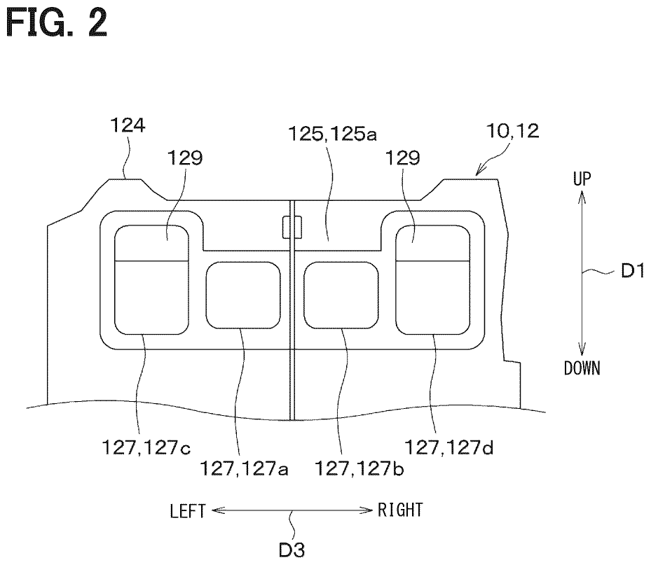

A vehicle air-conditioning device 1 of the present embodiment will be described with reference to FIGS. 1 to 7. The vehicle air-conditioning device 1 adjusts a temperature in a vehicle compartment by blowing air adjusted to a desired temperature into the vehicle compartment, which is a space to be air-conditioned. An arrow indicating up and down in FIG. 1 and the like indicates an up-down direction D1 in a state in which the vehicle air-conditioning device 1 is mounted on a vehicle. An arrow indicating front and rear in FIG. 1 and the like indicates a front-rear direction D2 in a state in which the vehicle air-conditioning device 1 is mounted on the vehicle. Furthermore, an arrow indicating left and right in FIG. 2 and the like indicates a left-right direction D3 in a state in which the vehicle air-conditioning device 1 is mounted on the vehicle.

The vehicle air-conditioning device 1 includes an air conditioning unit 10 and an air conditioning controller (not shown). The air conditioning unit 10 is arranged inside or at any other positions of an instrument panel disposed in a front part in the vehicle compartment.

The air conditioning unit 10 includes an air conditioning case 12, an inside-outside air unit (not shown), an evaporator 16, a blower fan 18, a heater core 20, an air mix door 22, and a mode switching door 24. The air conditioning unit 10 is configured as a suction type unit in which the blower fan 18 is arranged downstream of an air flow of the evaporator 16.

The air conditioning case 12 defines an air passage 120 through which air flows to be blown into the vehicle compartment. The air conditioning case 12 is made from a material having a certain degree of elasticity and high strength, for example, polypropylene.

Although not shown in the figure, the air conditioning case 12 has an outside air inlet for introducing outside air and an inside air inlet for introducing inside air at an uppermost point of the air flow. The air conditioning case 12 is also provided with an inside-outside air door for adjusting opening areas of the outside air inlet and the inside air inlet. The air conditioning unit 10 adjusts a ratio of outside air and inside air introduced into the inside of the air conditioning case 12 by the inside-outside air door.

The evaporator 16 is housed inside the air conditioning case 12, downstream of the air flow of the inside-outside air door. The evaporator 16 constitutes a vapor compression type refrigeration cycle together with a compressor, a radiator, an expansion valve, and the like (not shown). The evaporator 16 is a heat exchanger which evaporates a refrigerant flowing inside the evaporator 16 by exchanging heat with air which is blown into the vehicle compartment. In the evaporator 16, the refrigerant absorbs heat from the air, thereby cooling the air. The evaporator 16 is arranged inside the air conditioning case 12 so that all of the air flowing through the air passage 120 passes through the evaporator 16. In the present embodiment, the evaporator 16 constitutes a “cooling device” that cools the air flowing through the air passage 120.

The blower fan 18 is housed inside the air conditioning case 12, downstream of the air flow of the evaporator 16. The blower fan 18 generates an airflow that passes through the evaporator 16. The blower fan 18 includes a shaft 181 serving as a rotation axis, an impeller 182 that rotates integrally with the shaft 181, a motor 183, and the like. The blower fan 18 of the present embodiment is a centrifugal fan that draws in air in an axial direction along an axis CL of the shaft 181 and blows the air out in a direction away from the axis CL of the shaft 181.

Further, the air conditioning case 12 houses the heater core 20 that is arranged downstream of the air flow of the blower fan 18. The heater core 20 radiates heat from coolant water that cools in-vehicle devices that generate heat when the vehicle is in use, and from high-temperature, high-pressure refrigerant that flows through a refrigeration cycle, into the air, thereby heating the air. In the present embodiment, the heater core 20 constitutes a “heating device” that heats the air flowing through the air passage 120.

A cold-air bypass passage 121 is formed inside the air conditioning case 12 to allow air to bypass the heater core 20. More specifically, the cold-air bypass passage 121 includes a first bypass passage 121a and a second bypass passage 121b formed above and below the heater core 20, respectively, to allow air to flow around the heater core 20. The second bypass passage 121b is not essential and may be omitted.

The first bypass passage 121a of the cold-air bypass passage 121 is formed above the heater core 20. The first bypass passage 121a is adjacent to a defroster passage 122.

The defroster passage 122 is a passage inside the air conditioning case 12 that guides air that has passed through at least one of the heater core 20 and the cold-air bypass passage 121 to a defroster opening 126 described below.

The first bypass passage 121a and the defroster passage 122 are separated by a partition wall 123. The first bypass passage 121a extends rearward along the partition wall 123. In addition, the defroster passage 122 is formed between the partition wall 123 and an upper wall 124 of the air conditioning case 12.

The first bypass passage 121a and the defroster passage 122 have air flowing in opposite directions. That is, the air flowing through the first bypass passage 121a flows from the front to the rear. On the other hand, the air flowing through the defroster passage 122 flows from the rear to the front.

The partition wall 123 is integral with the air conditioning case 12. The partition wall 123 extends from above the blower fan 18 toward a rear wall 125 of the air conditioning case 12. The partition wall 123 extends along the front-rear direction D2 so as to intersect with the rear wall 125 of the air conditioning case 12.

An air mix space AMS is defined at a position downstream of the air flow of the heater core 20 and each bypass passage 121a, 121b in the air conditioning case 12. In the air mix space, the air that has passed through the heater core 20 and the air that has bypassed the heater core 20 are mixed together.

An air mix door 22 is arranged between the blower fan 18 and the heater core 20. The air mix door 22 adjusts a ratio of a volume of hot air passing through the heater core 20 to a volume of cold air passing through the cold-air bypass passage 121, thereby adjusting a temperature of the air blown into the vehicle compartment. The air mix door 22 includes two slide doors 221, 222 that move along an air inlet surface of the heater core 20. The air mix door 22 may be constituted by another type of door, such as a plate door.

In the air conditioning case 12, the defroster opening 126, a face opening 127, and a foot opening 128 are defined as blow-out openings downstream of the air flow of the heater core 20, and the mode switching door 24 is also arranged.

The defroster opening 126 is an opening through which air is blown toward an inner surface of a front glass window of the vehicle. The defroster opening 126 is defined in the upper wall 124 located above the evaporator 16 and the blower fan 18 in the air conditioning case 12. The defroster opening 126 is defined, for example, at a portion of the upper wall 124 that is located forward of the motor 183 of the blower fan 18. The defroster opening 126 communicates with a defroster blowing port through a duct not shown. The defroster opening 126 is opened and closed by a defroster door 241 included in the mode switching door 24. The defroster door 241 is a plate door.

The face opening 127 is an opening for blowing the air-conditioning air toward upper bodies of occupants seated in a front seat in the vehicle compartment. The face opening 127 is formed in the rear wall 125 of the air conditioning case 12. At least a portion of the face opening 127 is formed in a portion of the rear wall 125 that overlaps with the first bypass passage 121a in the front-rear direction D2. The rear wall 125 of the present embodiment has an upper portion that is inclined forward as an inclined portion 125a. The face opening 127 is formed at the inclined portion 125a.

As shown in FIG. 2, the face opening 127 of the present embodiment includes a pair of center-face openings 127a, 127b and a pair of side-face openings 127c, 127d.

The pair of center-face openings 127a, 127b are formed in a middle area of the rear wall 125 in the left-right direction D3. A pair of center-face openings 127a, 127b are connected to a center-face blowing port through a duct not shown. The air that has passed through the pair of center-face openings 127a, 127b is blown out from a middle area in the left-right direction D3 toward the upper body of the occupant.

The pair of side-face openings 127c, 127d are formed outside the pair of center-face openings 127a, 127b in the left-right direction D3. The pair of side-face openings 127c, 127d are connected to a side-face blowing port through a duct not shown. The air that has passed through the pair of side-face openings 127c, 127d is blown out from end sides in the left-right direction D3 toward upper bodies of occupants in the vehicle compartment and side windows.

The pair of center-face openings 127a, 127b and the pair of side-face openings 127c, 127d that configure the face opening 127 are opened and closed by a face door 242 included in the mode switching door 24.

The face door 242 is a sliding door SD. The face door 242 moves along an inner wall surface of the inclined portion 125a of the rear wall 125. A moving direction Ds of the face door 242 is a direction along the inner wall surface of the inclined portion 125a.

A rack gear RG is formed on an inner door surface of the face door 242 along the moving direction Ds of the face door 242. Pinion gears PG that mesh with the rack gear RG is disposed inside the air conditioning case 12 adjacent to the face door 242. More specifically, the pinion gears PG are disposed at a position closer to an upper end of the face opening 127 than to a lower end of the face opening 127. The pinion gears PG of the present embodiment are disposed on both sides in the left-right direction D3 so as to reduce resistance to the air passing through the face opening 127. That is, the pinion gears PG are disposed at a position closer to the pair of side-face openings 127c, 127d than to the pair of center-face openings 127a, 127b. The “inner door surface” of a door refers to a surface of a door that is behind a surface that covers an opening.

The face door 242 can be displaced between a position for closing the face opening 127 and a position for opening the face opening 127 by rotating the pinion gears PG. In the present embodiment, a state in which the face door 242 is in a position to close the face opening 127 is referred to as a “face closed state.”

The face opening 127 of the present embodiment is formed at a position upstream of the air flow of the defroster opening 126 in the face closed state. The air conditioning case 12 is structured such that, in the face closed state, air that has passed through the heater core 20 is guided along the inner door surface of the face door 242 to the defroster opening 126.

The foot opening 128 is an opening for blowing the air-conditioning air toward lower bodies of the occupants seated in the front seat in the vehicle compartment. The foot opening 128 is defined at a portion of the rear wall 125 of the air conditioning case 12 that is located on a lower position of the face opening 127. More specifically, the foot opening 128 is formed in a portion of the rear wall 125 that faces the heater core 20 in the front-rear direction D2. The foot opening 128 communicate with a foot blowing port through a duct not shown. The defroster opening 126 is opened and closed by a foot door 243 included in the mode switching door 24. The foot door 243 is a plate door.

Here, in the air conditioning case 12 of the present embodiment, gap openings 129 are formed adjacent to each of side-face openings 127c, 127d. The gap openings 129 are openings for blowing air from the side-face blowing port toward an inside of the side windows of the vehicle in the face closed state. The gap openings 129 connect the air flow upstream and downstream of the face door 242 in the face closed state. An opening area of a gap opening 129, which is one of the gap openings 129, is smaller than an opening area of the face opening 127.

The gap opening 129 is closed by the face door 242 when the face door 242 is displaced to an open position where the face opening 127 is opened. It should be noted that the gap opening 129 may be closed by an element other than the face door 242.

Here, in the face closed state, if the gap opening 129 is open in a direction that intersects with the inner door surface of the face door 242, a high-temperature air heated by the heater core 20 is likely to be blown out excessively near an occupant's face through the gap opening 129. This is undesirable since it reduces comfort inside the vehicle compartment.

In contrast, the gap opening 129 has an opening plane that is aligned with the moving direction Ds of the face door 242, similar to each of the side-face openings 127c, 127d. This makes it easier for the warm air flowing along the inner door surface of the face door 242 to flow along the opening plane of the gap opening 129, thereby preventing excessive flow into the gap opening 129. An “opening plane” refers to a surface passing through an edge portion that constitutes an opening.

In addition, the air conditioning case 12 has a ventilation structure in which, in the face closed state, the air that has passed through the heater core 20 flows along the opening plane of the gap opening 129, and the air that has bypassed the heater core 20 flows in a direction that intersects with the opening plane of the gap opening 129. With such the ventilation structure, cold air that bypasses the heater core 20 or a mixture of cold air and warm air is capable of flowing into the gap opening 129, thereby preventing excessive flow of high-temperature air heated by the heater core 20 into the gap opening 129.

The partition wall 123 of the present embodiment extends in a direction intersecting with the opening plane of the gap opening 129. That is, the gap opening 129 has an opening plane that expands in a direction intersecting the front-rear direction D2, which is the extension direction of the partition wall 123.

The gap opening 129 opens into a wall surface located downstream in the air flow direction of the side-face openings 127c, 127d of the air conditioning case 12 and upstream in the air flow direction of the defroster opening 126. More specifically, the gap opening 129 is formed in a portion of the rear wall 125 forward of each of the side-face openings 127c, 127d.

Furthermore, the gap opening 129 is formed in the rear wall 125 near the inclined portion 125a that faces the first bypass passage 121a across the air mix space AMS. The gap opening 129 opens into a wall surface located downstream in the air flow direction of the air mix space AMS in the air conditioning case 12.

More specifically, the gap opening 129 communicates with each of the side-face openings 127c, 127d. More specifically, the gap opening 129 is formed to be continuous with the front of upper end portions of the side-face openings 127c, 127d that are closed by the face door 242.

As described above, in the air conditioning case 12 of the present embodiment, in the face closed state, air that has passed through the heater core 20 is guided to the defroster opening 126 along the inner door surface of the face door 242 and the opening plane of the gap opening 129. At this time, a portion of the warm air flowing along the inner door surface of the face door 242 collides with the pinion gears PG and tends to flow away from the inner door surface of the face door 242. Taking this into consideration, the gap opening 129 of the present embodiment is formed in the wall surface of the air conditioning case 12 that is located downstream in the air flow direction from the pinion gears PG.

The air conditioning unit 10 thus configured is controlled in operation by the air conditioning controller. The air conditioning controller includes a microcontroller having a processor and a memory, and peripheral circuits. The air conditioning controller performs various calculations and processes based on control programs stored in the memory and controls the operation of various devices connected to the air conditioning controller. Various air conditioning control sensors and air conditioning operation panels (not shown) are connected to an input side of the air conditioning controller. Various control devices such as the blower fan 18, the air mix door 22, and the mode switching door 24 are connected to an output side of the air conditioning controller.

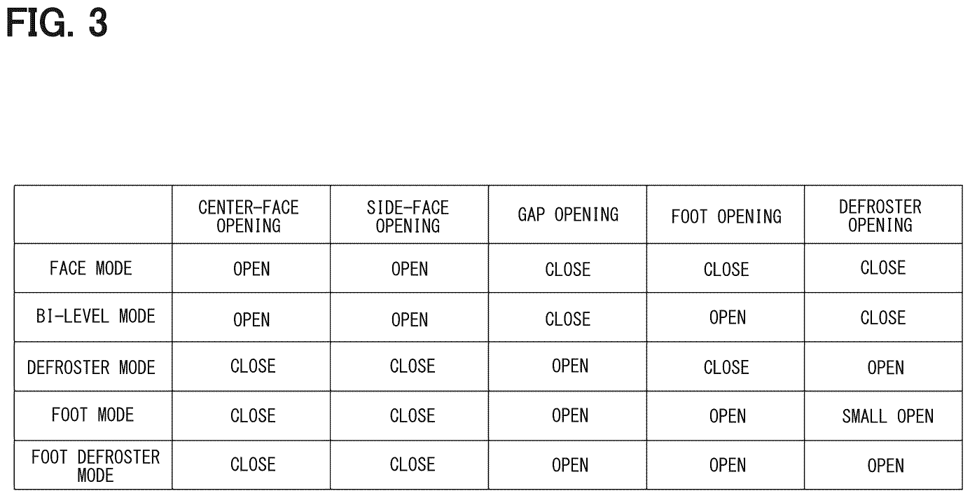

The air conditioning controller changes an air blowing mode based on, for example, an output signal from the air conditioning control sensors and an operation signal from the air conditioning operation panel. The air conditioning unit 10 of the present embodiment can be set to five modes: a face mode, a bi-level mode, a defroster mode, a foot mode, and a foot defroster mode. FIG. 3 shows an opening state and a closing state of openings in the five modes.

### [Face Mode]

As shown in FIG. 2, the face mode is a mode in which the face opening 127 is opened to blow air toward the upper body of the occupant. In the face mode, the face door 242 is displaced to a position that opens the face opening 127, thereby closing the gap opening 129.

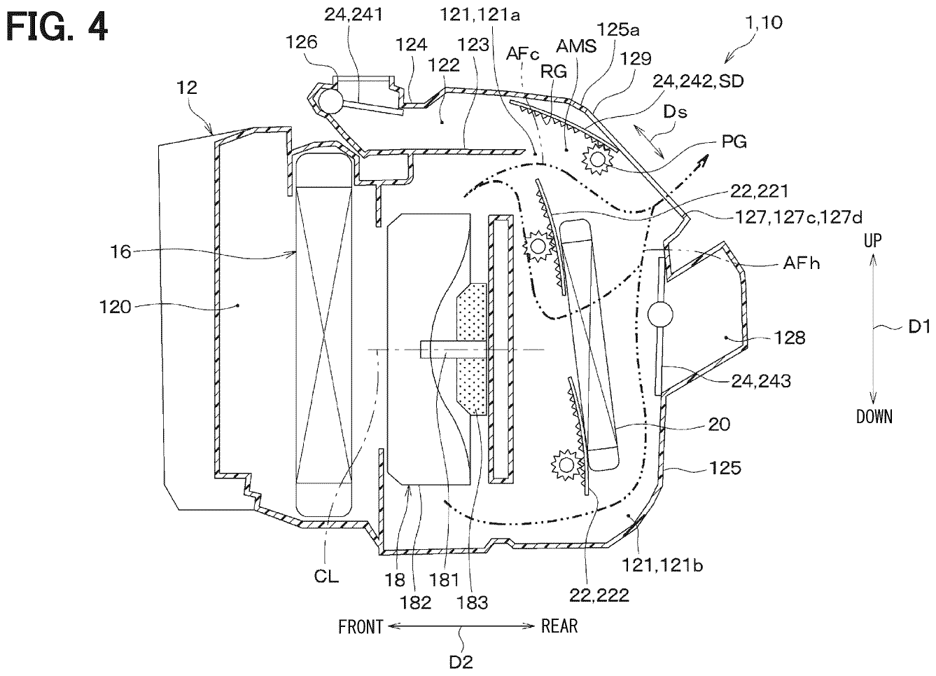

In the face mode, the cool air that bypasses the heater core 20 flows toward the face opening 127 along the partition wall 123 as indicated by an arrow AFc in FIG. 4. Furthermore, the hot air that has passed through the heater core 20 flows along the rear wall 125 and the foot door 243 toward the face opening 127, as indicated by an arrow AFh in FIG. 4. Then, air adjusted to an appropriate temperature by mixing cold air and hot air flows through the face opening 127.

### [Bi-Level Mode]

The bi-level mode is a mode in which both the face opening 127 and foot opening 128 are open to blow air toward both the upper and lower body of the occupant. In the bi-level mode, the face door 242 is displaced to a position that opens the face opening 127, thereby closing the gap opening 129.

In the bi-level mode, the cool air that bypasses the heater core 20 flows along the partition wall 123 toward the face opening 127. In addition, the hot air that has passed through the heater core 20 flows toward the foot opening 128. As a result, relatively cool air is provided to the occupant through the face opening 127 and relatively warm air is provided to the occupant through the foot opening 128. This allows for comfortable air conditioning with a cool head and warm feet.

### [Defroster Mode]

The defroster mode is a mode in which the defroster opening 126 is opened to blow air toward the inner surface of the front glass of the vehicle. In the defroster mode, the face door 242 is displaced to a position for closing the face opening 127, thereby opening the gap opening 129.

In the defroster mode, the cool air bypassing the heater core 20 flows along the partition wall 123 toward the face opening 127 and the gap opening 129 as indicated by an arrow AFc in FIG. 1. In addition, the hot air that has passed through the heater core 20 flows toward the defroster passage 122 along the rear wall 125, the foot door 243, the face door 242, and the opening plane of the gap opening 129, as shown by an arrow AFh in FIG. 1.

As a result, the hot air that has passed through the heater core 20 flows easily through the defroster opening 126, while the cold air that bypasses the heater core 20 is less likely to flow through the defroster opening 126. Therefore, hot air or a mixture of hot air and cold air tends to flow through the defroster opening 126.

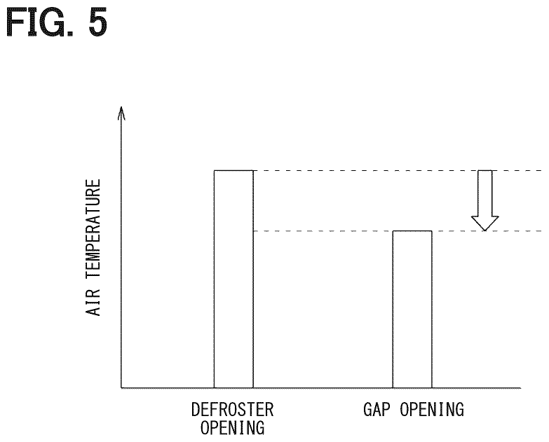

On the other hand, the cool air that bypasses the heater core 20 flows easily through the gap opening 129, while the warm air that has passed through the heater core 20 does not flow easily through the gap opening 129. Therefore, for example, as shown in FIG. 5, the air that is cooler than the air that passes through the defroster opening 126 passes through the gap opening 129.

### [Foot Mode]

The foot mode is a mode in which the foot opening 128 is opened and the defroster opening 126 is opened slightly to blow air toward the lower body of the occupant while blowing a small amount of air toward the inside of the front window glass of the vehicle. In the foot mode, the face door 242 is displaced to a position that closes the face opening 127, thereby opening the gap opening 129.

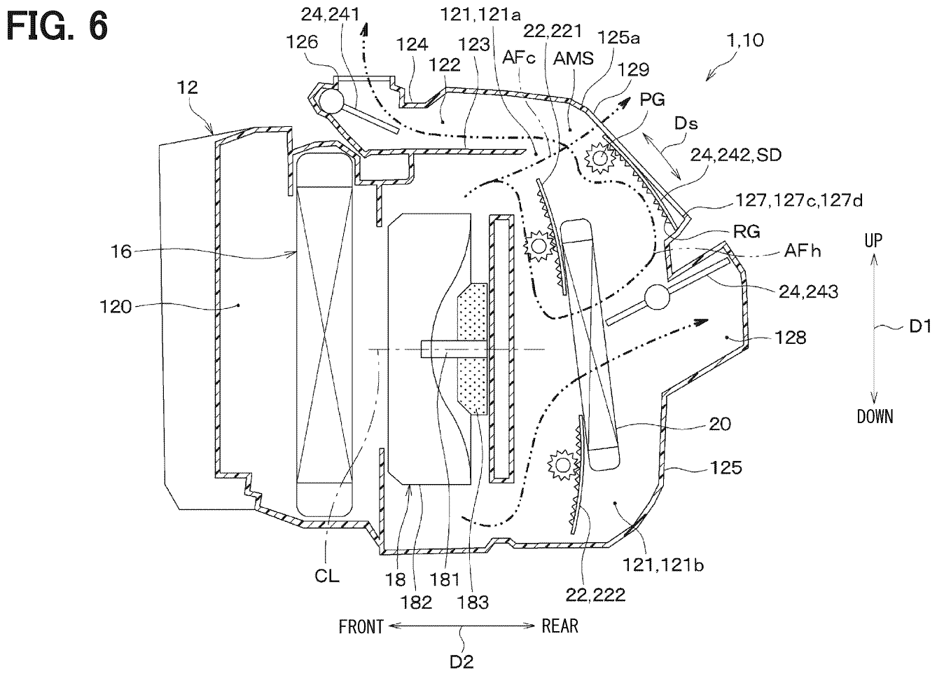

In the foot mode, the cool air that bypasses the heater core 20 flows along the partition wall 123 toward the face opening 127 and the gap opening 129 as indicated by an arrow AFc in FIG. 6. As shown by an arrow AFh in FIG. 6, most of the warm air that passes through the heater core 20 flows along the foot door 243 toward the foot opening 128, and the remainder flows along the rear wall 125, the face door 242, and the opening plane of the gap opening 129 toward the defroster passage 122.

As a result, the hot air that has passed through the heater core 20 flows more easily through the defroster opening 126 and the foot opening 128, while the cold air that bypasses the heater core 20 is less likely to flow through them. Therefore, hot air or a mixture of hot air and cold air tends to flow through the defroster opening 126 and the foot opening 128.

On the other hand, the cool air that bypasses the heater core 20 flows easily through the gap opening 129, while the warm air that has passed through the heater core 20 does not flow easily through the gap opening 129. Therefore, the air that is cooler than the air that passes through the defroster opening 126 and the foot opening 128 passes through the gap opening 129.

### [Foot Defroster Mode]

The foot defroster mode is a mode in which the defroster opening 126 and the foot opening 128 are opened to blow air toward the lower body of the occupant and toward the inside of the front window of the vehicle. In the foot defroster mode, the face door 242 is displaced to a position for closing the face opening 127, thereby opening the gap opening 129.

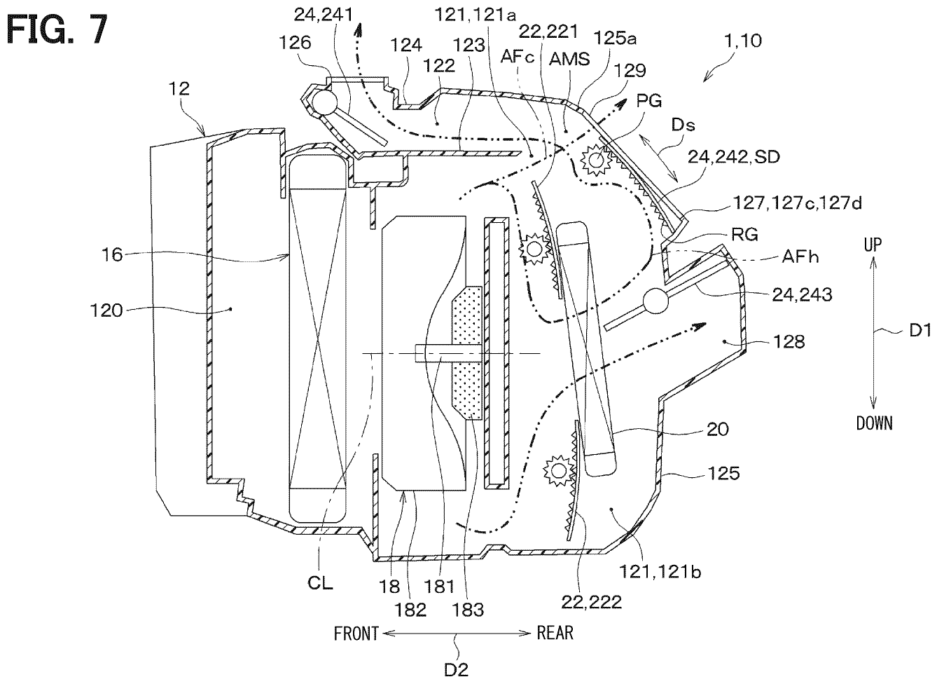

In the foot defroster mode, the cool air bypassing the heater core 20 flows along the partition wall 123 toward the face opening 127 and the gap opening 129 as indicated by an arrow AFc in FIG. 7. As shown by an arrow AFh in FIG. 7, a portion of the warm air that passes through the heater core 20 flows along the foot door 243 toward the foot opening 128, and the remainder flows along the rear wall 125, the face door 242, and the opening planes of the gap opening 129 toward the defroster passage 122. This makes it easier for the warm air that has passed through the heater core 20 to flow to the defroster opening 126 and the foot opening 128, and makes it easier for the air that is cooler than the air that passes through the defroster opening 126 and the foot opening 128 to flow to the gap opening 129.

In the vehicle air-conditioning device 1 described above, the gap opening 129 that connects the upstream and downstream air flows of the face door 242 in the face closed state is formed adjacent to the pair of side-face openings 127c, 127d. The gap opening 129 has the opening plane that is aligned with the moving direction Ds of the face door 242.

In this way, if the gap opening 129 is opened along the moving direction Ds of the face door 242, the warm air flowing along the inner door surface of the face door 242 will be more likely to flow along the opening plane of the gap opening 129, thereby reducing excessive flow into the gap opening 129.

In addition, the air conditioning case 12 has a ventilation structure in which, in the face closed state, the air that has passed through the heater core 20 flows along the opening plane of the gap opening 129, and the air that has bypassed the heater core 20 flows in a direction that intersects with the opening plane of the gap opening 129.

As a result, the warm air that has passed through the heater core 20 is capable of easily flowing along the opening plane of the gap opening 129 to the defroster opening 126, and the cold air that flows around the heater core 20 or the temperature-controlled air that is a mixture of the cold air and the warm air is capable of easily flowing to the gap opening 129. Therefore, in the face closed state, the high-temperature air heated by the heater core 20 is prevented from flowing excessively through the gap opening 129. In addition, in the face closed state, the high-temperature air heated by the heater core 20 is capable of easily flowing through the defroster opening 126, thereby preventing the front windshield of the vehicle from fogging up.

Further, the vehicle air-conditioning device 1 of the present embodiment has the following features.

The face door 242 is provided with the rack gear RG on the inner door surface of the face door 242. The pinion gears PG that mesh with the rack gear RG is disposed inside the air conditioning case 12 adjacent to the face door 242. The gap opening 129 opens into the wall surface located downstream in the air flow direction of the pinion gears PG in the air conditioning case 12 in the face closed state. In the vehicle air-conditioning device 1, in the face closed state, a portion of the warm air flowing along the inner door surface of the face door 242 collides with the pinion gears PG and tends to flow away from the inner door of the face door 242, as shown by the arrow AFh in FIG. 1. Therefore, if the gap opening 129 is formed downstream of the pinion gears PG in the air flow, excessive flow of the high-temperature air heated by the heater core 20 into the gap opening 129 is reduced in the face closed state.

On the inside of the air conditioning case 12, the cold-air bypass passage 121 that allows air to bypass the heater core 20, the defroster passage 122 that guides air that has passed through at least one of the heater core 20 and the cold-air bypass passage 121 to a defroster opening 126 are formed. The cold-air bypass passage 121 is formed adjacent to the defroster passage 122 and extends along the partition wall 123 between the cold-air bypass passage 121 and the defroster passage 122. The partition wall 123 extends in the direction intersecting with the opening plane of the gap opening 129.

According to this, the cold air flowing through the cold-air bypass passage 121 is capable of easily flowing along the partition wall 123 to the gap opening 129, thereby preventing excessive flow of the high-temperature air heated by the heater core 20 into the gap opening 129.

In addition, in the present embodiment, the partition wall 123 between the cold-air bypass passage 121 and the defroster passage 122 is utilized to guide the cold air flowing through the cold-air bypass passage 121 to the gap opening 129. Therefore, there is no need to provide temperature adjustment ribs or dedicated guides inside the air conditioning case 12. This makes it possible to reduce an increase in ventilation resistance inside the air conditioning case 12 and to reduce an increase in noise.

In the air conditioning case 12, in the face closed state, the gap opening 129 is opened in the wall surface that is downstream in the air flow direction of the pair of side-face openings 127c, 127d and upstream in the air flow direction of the defroster opening 126. In this manner, by arranging the gap opening 129 downstream of the pair of side-face openings 127c, 127d, the mixture of cool air and hot air is capable of easily flowing through the gap opening 129. This prevents the high-temperature air heated by the heater core 20 from flowing excessively through the gap opening 129.

The air mix space AMS is provided inside the air conditioning case 12, downstream of the heater core 20, which allows the air that has passed through the heater core 20 in the face closed state to merge with the air that has bypassed the heater core 20. The gap opening 129 opens into the wall surface located downstream in the air flow of the air mix space AMS in the air conditioning case 12 in the face closed state. In this way, by forming the gap opening 129 downstream of the air mix space AMS, it becomes easier for the air resulting from the mixture of the high-temperature air heated by the heater core 20 and the air flowing around the heater core 20 to flow into the gap opening 129. This prevents the high-temperature air heated by the heater core 20 from flowing excessively through the gap opening 129.

In the vehicle air-conditioning device 1 of the present embodiment, the face door 242 is a sliding door SD. In this configuration, unlike a panel door or a rotary door, a cold air passage and a hot air passage are not blocked when the face opening 127 is opened or closed. Therefore, a certain amount of passage area can be secured around the face opening 127. In addition, the ventilation resistance around the face opening 127 can be reduced and the noise can be reduced.

In addition, the air conditioning unit 10 is configured to, in the face closed state, use the inner door surface of the face door 242 to guide the warm air that has passed through the heater core 20 to the defroster opening 126. This makes it possible to guide the high temperature air to the defroster opening 126 with a simple configuration. Furthermore, since there is no need to add ribs or the like for adjusting temperature, the ventilation resistance and the noise can be reduced.

### Modification to First Embodiment

As in the first embodiment, the gap opening 129 opens to the wall surface located downstream in the air flow direction of the pinion gears PG in the air conditioning case 12 in the face closed state, but this is not limited thereto.

The vehicle air-conditioning device 1 is not limited to having the gap openings 129 adjacent to each of the side-face openings 127c, 127d of the air conditioning case 12. The gap opening 129 may be formed not in the air conditioning case 12 but, for example, in a portion of the face door 242 that opens and closes each of the side-face openings 127c, 127d.

The air conditioning case 12 should have a ventilation structure in which air passing through the heater core 20 flows along the opening plane of the gap opening 129 and air bypassing the heater core 20 flows in the direction that intersects the opening plane of the gap opening 129, but is not limited to this. The air conditioning case 12 may have a ventilation structure different from that described above.

The air conditioning unit 10 is configured as an intake type unit in which a blower fan 18 is arranged downstream of the air flow of the evaporator 16, but is not limited to this, and may also be configured as a push-in type unit in which a blower fan 18 is arranged downstream of the air flow of the evaporator 16.

### Second Embodiment

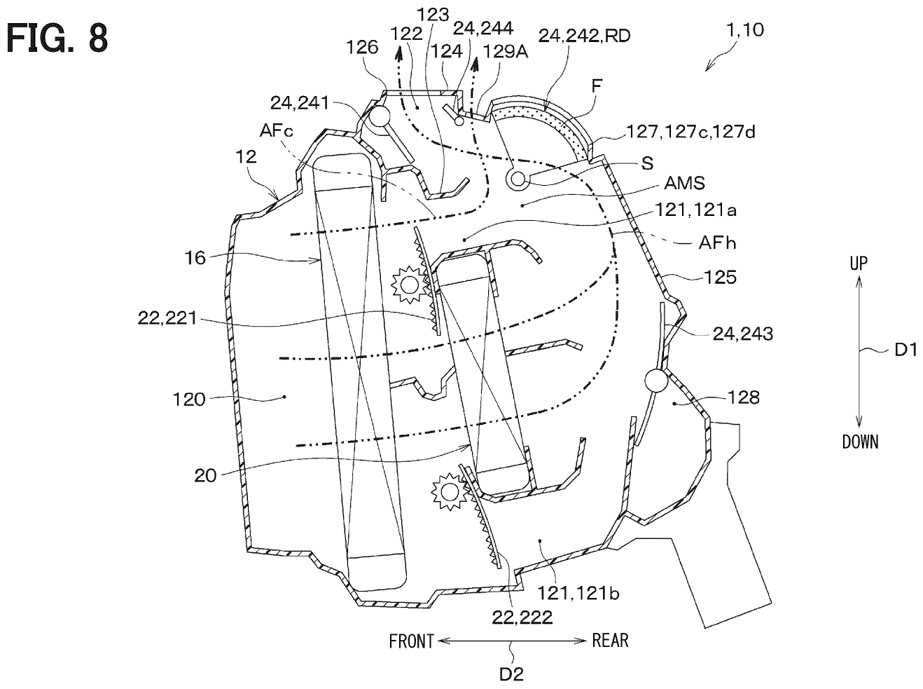

Next, a second embodiment will be described with reference to FIG. 8. In the present embodiment, differences from the first embodiment will be mainly described.

In a vehicle air-conditioning device 1 of the present embodiment, an air conditioning unit 10 is configured as a forced-in type unit in which a blower fan 18 is arranged upstream of an air flow of an evaporator 16. Although not shown, the blower fan 18 is arranged between an inside-outside air unit and the evaporator 16.

As shown in FIG. 8, an air conditioning case 12 has at least a part of a face opening 127 formed in a portion of a rear wall 125 that overlaps with a first bypass passage 121a in a front-rear direction D2. The rear wall 125 of the present embodiment is substantially entirely inclined forward.

The face door 242 is a rotary door RD rather than a slide door SD. The rotary door RD has a door shaft S and an opening-closing portion F having a plate portion curved along a rotation direction of the door shaft S. The face door 242 configured in this manner is capable of displacing the opening-closing portion F between a position for closing the face opening 127 and a position for opening the face opening 127 by rotating the door shaft S.

The face opening 127 is formed at a position upstream of the air flow of a defroster opening 126 in a face closed state. The air conditioning case 12 is structured such that, in the face closed state, air that has passed through the heater core 20 is guided along the inner door surface of the face door 242 to the defroster opening 126.

Gap openings 129A are formed adjacent to each of the side-face openings 127c, 127d of the air conditioning case 12, respectively. The gap openings 129A are formed separately from each of the side-face openings 127c, 127d.

The gap openings 129A are opened and closed by an opening-closing door 244 included in the mode switching door 24. The opening-closing door 244 is a plate door. The opening-closing door 244 may be configured as a door other than a plate door.

The opening-closing door 244 operates in conjunction with the face door 242. More specifically, when the face opening 127 is closed by the face door 242, the opening-closing door 244 opens the gap openings 129A. Furthermore, when the face opening 127 is opened by the face door 242, the opening-closing door 244 closes the gap openings 129A. That is, in the face closed state, the gap openings 129A are opened by the opening-closing door 244.

The air conditioning case 12 of the present embodiment is configured so that the hot air that has passed through the heater core 20 is prevented from flowing excessively into the gap openings 129A. The air conditioning case 12 has a ventilation structure in which, in the face closed state, the air that has passed through the heater core 20 flows along the opening plane of the gap openings 129A, and the air that has bypassed the heater core 20 flows in a direction that intersects with the opening plane of the gap openings 129A.

In the vehicle air-conditioning device 1 configured in this manner, for example, in a defroster mode, the cold air bypassing the heater core 20 flows along the partition wall 123 toward the face opening 127 and the gap openings 129A, as shown by an arrow AFc in FIG. 8. In addition, the hot air that has passed through the heater core 20 flows toward the defroster passage 122 along the rear wall 125, the face door 242, and the opening plane of the gap openings 129A, as shown by an arrow AFh in FIG. 8.

Therefore, hot air or a mixture of hot air and cold air tends to flow through the defroster opening 126. On the other hand, the cool air that bypasses the heater core 20 flows easily through the gap opening 129, while the warm air that has passed through the heater core 20 does not flow easily through the gap openings 129A. Therefore, air that is cooler than the air that passes through the defroster opening 126 is more likely to pass through the gap openings 129A.

Others are the same as those in the first embodiment. The vehicle air-conditioning device 1 of the present embodiment can achieve effects obtained from the common configuration or the equivalent configuration to the first embodiment.

Further, the vehicle air-conditioning device 1 of the present embodiment has the following features.

In the vehicle air-conditioning device 1, the face door 242 is configured as the rotary door RD rather than a sliding door SD, and the gap openings 129A are opened and closed by the opening-closing door 244 separate from the face door 242. The air conditioning case 12 has the ventilation structure in which, in the face closed state, the air that has passed through the heater core 20 flows along the opening plane of the gap openings 129A, and the air that has bypassed the heater core 20 flows in the direction that intersects with the opening plane of the gap openings 129A.

With such the ventilation structure, cold air that bypasses the heater core 20 or a mixture of cold air and warm air is capable of flowing into the gap openings 129A, thereby preventing excessive flow of high-temperature air heated by the heater core 20 into the gap opening 129.

### Modification of Second Embodiment

The air conditioning unit 10 of the second embodiment is configured as a push-in type unit in which the blower fan 18 is arranged upstream of the air flow of the evaporator 16, but is not limited to this and may be configured as a suction type unit.

The face door 242 in the second embodiment is the rotary door RD, but is not limited to this. The face door 242 may be another door, such as a plate door.

Furthermore, the gap openings 129 are not limited to being formed separately from each of the side-face openings 127c, 127d, but may be connected to each of the side-face openings 127c, 127d.

### Other Embodiments

Although the representative embodiments of the present disclosure have been described above, the present disclosure is not limited to the above-described embodiments, and can be variously modified as follows, for example:

The cold-air bypass passage 121 in the above-described embodiment is formed adjacent to the defroster passage 122, the present disclosure is not limited to this. For example, the heater core 20 may be arranged adjacent to the defroster passage 122.

The vehicle air-conditioning device 1 of the above-described embodiment is configured to heat the air flowing through the air passage 120 by the heater core 20, but is not limited to this. The vehicle air-conditioning device 1 may be configured to heat the air flowing through the air passage 120 by, for example, an electric heater.

The air conditioning case 12 of the present embodiment is configured so that the partition wall 123 between the first bypass passage 121a and the defroster passage 122 guides the cold air that has passed through the first bypass passage 121a to the gap opening 129, but this is not limited to this.

The air conditioning case 12 may be configured such that the cool air that has passed through the first bypass passage 121a is guided to the gap opening 129 by a guide rib separate from the partition wall 123. In this case, the partition wall 123 does not need to extend in a direction intersecting the opening plane of the gap opening 129.

The air conditioning case 12 has the gap opening 129 opened downstream in the air flow direction of the pair of side-face openings 127c, 127d and upstream in the air flow direction of the defroster opening 126, but this is not limited to this. The gap opening 129 may be provided, for example, upstream of the pair of side-face openings 127c, 127d in the air flow direction.

In addition, the gap opening 129 is open at a position downstream of the air flow of the air mix space AMS in the air conditioning case 12 in the face closed state, but this is not essential.

In the above embodiment, a specific example of the vehicle air-conditioning device 1 is given, but the present disclosure is not limited to this example, and some of the components of the vehicle air-conditioning device 1 may be different from those described above. The vehicle air-conditioning device 1 may be a two-layer upper and lower air conditioning unit 10 or a left and right independent control air conditioning unit 10.

Needless to say, the elements constituting the above embodiments are not necessarily essential, except for cases, such as a case where it is clearly indicated that the elements are particularly essential, and a case where it is considered that the elements are obviously essential in principle.

In the above-described embodiment, in a case where numerical values, such as the numbers, numerical values, amounts, and ranges, of constituent elements of the embodiments are mentioned, the specific numbers are not limitative, except for cases, such as a case where it is clearly indicated that the numerical values are particularly essential, and a case where the numerical values are obviously limited to the specific numbers in principle.

In the above-described embodiments, when the shapes, positional relationships, and the like of the constituent elements and the like are mentioned, the shapes, positional relationships, and the like are not limitative, except for cases, such as a case where it is clearly indicated, and a case where the specific shapes, positional relationships, and the like are limitative in principle.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A vehicle air-conditioning device comprising:
an air conditioning case defining an air passage for air to be blown into a vehicle compartment of a vehicle; and
a heating device for heating air flowing through the air passage, wherein
the air conditioning case is formed with a defroster opening for blowing air toward an inner surface of a front windshield of the vehicle, and a side-face opening for blowing air into the vehicle compartment from end parts in a left-right direction of the vehicle,
a defroster door for opening and closing the defroster opening and a face door for opening and closing the side-face opening are provided inside the air conditioning case,
the face door is a slide door for opening and closing the side-face opening by moving along an opening plane of the side-face opening,
the air conditioning case has a structure in which air that has passed through the heating device is guided along an inner door surface of the face door to the defroster opening in a face closed state in which the face door closes the side-face opening,
a gap opening for communication between upstream and downstream of the face door in an air flow direction in the face closed state is formed adjacent to the side-face opening,
the gap opening has an opening plane along a moving direction of the face door, and
the gap opening is configured to open and close.

2. The vehicle air-conditioning device according to claim 1, wherein
the inner door surface of the face door is provided with a rack gear,
the rack gear meshes with a pinion gear located adjacent to the face door and inside the air conditioning case, and
the gap opening is open in a wall surface of the air conditioning case which is located downstream of the pinion gear in the air flow direction in the face closed state.

3. The vehicle air-conditioning device according to claim 1, wherein
the air conditioning case has a ventilation structure in which, in the face closed state, air that has passed through the heating device flows along the opening plane of the gap opening, and air that has passed around the heating device flows in a direction which intersects with the opening plane of the gap opening.

4. A vehicle air-conditioning device comprising:
an air conditioning case defining an air passage for air to be blown into a vehicle compartment of a vehicle; and
a heating device for heating air flowing through the air passage, wherein
the air conditioning case is formed with a defroster opening for blowing air toward an inner surface of a front windshield of the vehicle, and side-face opening for blowing air into the vehicle compartment from end parts in a left-right direction of the vehicle,
a defroster door for opening and closing the defroster opening and a face door for opening and closing the side-face opening are provided inside the air conditioning case,
a gap opening for communication between upstream and downstream of the face door in an air flow direction in a face closed state, in which the face door closes the side-face opening, is formed adjacent to the side-face opening,
the air conditioning case has a ventilation structure in which, in the face closed state, air that has passed through the heating device is guided to the defroster opening along an opening plane of the gap opening, and air that has passed around the heating device flows in a direction which intersects with the opening plane of the gap opening, and
the gap opening is configured to open and close.

5. The vehicle air-conditioning device according to claim 4, wherein
the air conditioning case defines a cold-air bypass passage for allowing air to flow while bypassing the heating device, and a defroster passage for guiding air that has passed through at least one of the heating device and the cold-air bypass passage to the defroster opening,
the cold-air bypass passage is located adjacent to the defroster passage and extends along a partition wall provided between the cold-air bypass passage and the defroster passage, and
the partition wall extends in a direction which intersects with the opening plane of the gap opening.

6. The vehicle air-conditioning device according to claim 1, wherein
the gap opening is open in a wall surface of the air conditioning case at a downstream side of the side-face opening and at an upstream side of the defroster opening in the air flow direction in the face closed state.

7. The vehicle air-conditioning device according to claim 1, wherein
the air conditioning case defines an air mix space, which is located downstream of the heating device in the air flow direction, and in which, in the face closed state, air that has passed through the heating device and air that has passed around the heating device are mixed together in the air mix space, and
the gap opening is open in a wall surface of the air conditioning case at a downstream side of the air mix space in the air flow direction in the face closed state.
